(19) United States
(12) Patent Application Publication
(10) Pub. No.: US 2019/0030379 A1
(43) Pub. Date: Jan. 31, 2019

(54) DEVICE FOR INFLATING AN INFLATABLE BAG, AVALANCHE SAFETY SYSTEM AND A BACKPACK WITH SUCH A DEVICE AND USE

(71) Applicant: RAS Technology Sàrl, Lignières (CH)

(72) Inventor: Marc-Antoine SCHAER, Lignières (CH)

(21) Appl. No.: 16/072,966

(22) PCT Filed: Jan. 24, 2017
(86) PCT No.: PCT/EP2017/051353

§ 371 Date: Jul. 26, 2018

(30) Foreign Application Priority Data
Feb. 8, 2016 (EP) 16154686.6

(51) Int. Cl. A62B 33/00

(52) U.S. Cl. CPC A62B 33/00; A45F 3/04

(57) ABSTRACT

A device (1) for inflating an inflatable bag. The device comprises a first opening (11) which allows intake of atmospheric air, a second opening (12) connected or connectable to the inflatable bag, at least a first moveable inflation member (13), preferably an impeller, being arranged between the first opening (11) and the second opening (12), a motor (31) for driving the moveable inflation member (13) and a power source for energizing the motor (31). The power source comprises at least one capacitor (21) as a power supply for the motor (31).

This application is a national stage completion of PCT/EP2017/051353 filed Jan. 24, 2017 which claims priority from European Application Serial No. 16154688.6 filed Feb. 8, 2016.

### FIELD OF THE INVENTION

The present invention relates to a device for inflating an inflatable bag, an avalanche safety system comprising such a device, a backpack comprising such a device and the use of a capacitor according to the preamble of the independent claims.

### BACKGROUND OF THE INVENTION

In the prior art, several attempts have been made to increase chances of survival while getting into an avalanche or being buried by an avalanche. Safety devices exist that allow finding a buried person within a short period after an accident with an avalanche. Such devices are known as avalanche transceivers.

Further safety devices are based on using inflatable bags which are blown up while or after release of an avalanche. Such bags reduce the risk of being fully buried by snow as the inflated bag tends to float on the surface of the snow. Thus, a person carrying such an inflatable back rather stays on the snow surface or near the snow surface of an avalanche. The person is either still able to get out of the snow without help or the person can be found and rescued by another person more quickly as the inflated back increases the probability that at least a part of the buried person or the inflated bag is visible at the snow surface of the avalanche debris. Furthermore the bag may reduce head injuries and also provide a hollow space neighbouring the person.

Known devices are operated with pressurized gases. EP 2 700 433 A2 discloses a device comprising a movable inflation member which is driven by a motor which uses energy of a battery.

This device is disadvantageous due to the heavy weight of the battery.

Furthermore, the capacity of the battery might change during changes of ambient temperature. Thus, a user might wrongly assume, that the battery is fully charged, as said status was checked at home being at room temperatures. A temperature drop, caused by a possible temperature difference of more than 20° C. between inside and outside, might change the capacity of the battery from full to almost empty. Furthermore, batteries lose their power at low temperature, i.e. below 0° C. Avalanche devices must be functional at even −30° C. In order to provide sufficient energy at such low temperatures, batteries are oversized and thus large, heavy and expensive. Thus, the disadvantages of the batteries as used in the prior art relate to reduced energy supply at temperatures below 0° C., long duration of charging and limitations in usability and transportation for the use in an avalanche safety system (due to large size and weight). Additionally, the number of charging/discharging cycles and the lifetime of a battery are limited. There may also be safety constraints regarding usage, transportation, shipping and storage due to the chemical content of the battery.

WO 2012/035422 A1 discloses an airbag system as a rescue or life-saving system to enable a person to survive an avalanche. The system bases on an electric motor for moving a portion of an air movement device, such as a fan blade, to move ambient air into the airbag. The power source of the electric motor may be a heated or self--heated battery to avoid the impact of temperature changes on functionality. The system still has the drawback of a heavy battery.

It is therefore an objective of the invention to solve the drawbacks of the prior art. In particular, it is an objective of the invention to provide a lightweight device for inflating an inflatable bag, which is resistant to outside temperature conditions. Furthermore, the activity of the device should not change during one or a few subsequent days without triggering the device. These objectives are solved with the device according to claim 1.

### SUMMARY OF THE INVENTION

According to the present invention the device is suitable for inflating an inflatable bag. The device comprises a first opening. The first opening allows the intake of atmospheric air. A second opening is connectable or connected to an inflatable bag. The device further comprises a first moveable inflation member for transferring (e.g. blowing) ambient air into the bag, preferably an impeller. The first moveable inflation member is arranged between said first opening and said second opening. The device further comprises an electric motor for driving the moveable inflation member and a power source for energizing the motor.

According to the invention the power source comprises at least one capacitor as a power supply for said motor. Such a device is not sensitive to extreme temperature conditions, e.g. ranging from 30° C. to 50° C. The energy level of the capacitor is constant under such extreme conditions, which is advantageous in particular when used in an avalanche safety system. The capacitor is able to provide and supply a high amount of energy to the motor in a short period of time in order to inflate the inflatable bag within seconds. The use of at least one capacitor allows to make a lightweight device. Another advantage is that capacitors do not have transportation constraints, e.g. in airplanes or shipping with postal services.

Capacitors may be connected to form a capacitor module such as supercapacitors or ultracapacitors. The following mechanism relating to the energy storage of a capacitor applies similarly to supercapacitors and ultracapacitors. A capacitor can store energy in the form of an electrostatic field in contrast to a battery which uses a chemical reaction for electrical charging and discharging. In capacitors, electricity is stored or released much faster since there is no electrochemical process involved. The capacitor can be recharged in few minutes which is 10,000 times faster than traditional batteries and offer an extremely high power in a short period of time. Additionally, capacitors go through 500,000 charging discharging cycles without decrease in performance. In contrast, the lifetime of batteries is usually in the range of 3 to 5 years.

Specifically, the energy storage in a battery or a capacitor is due to their ability to transfer and store ions (charged particles). Both devices have at their base an electrolyte, a mixture of positive and negative ions. In a battery, chemical reactions displace the ions from the electrolyte to the inside or outside of the atomic structure of the material composing the electrode, resulting in a change of oxidation state of the material, depending on whether the battery is charged or discharged. In contrast, a capacitor uses an electric field causing the ions to move to or from the electrode surface without a redox reaction. Since the ions are only adsorbed and released on the electrodes, no chemical reaction takes place. Thus, a capacitor can be rapidly charged and discharged multiple times. As a battery stores ions due to the aforementioned redox reaction hi the volume of the materials, the battery can store a large amount of energy. However, the battery does not store ions at the surface of the electrodes compared to a capacitor.

The capacitor may have a total capacitance in the range of 20 to 90, preferably 50 F to 70 F, more preferably 58 F.

The rated voltage of the capacitor may be 16 V; the absolute maximum voltage of the capacitor may be 17V.

The maximum continuous current of the capacitor may be 35 A; the maximum peak current of the capacitor may be 203 A, preferably in the range of 80 to 100 A.

The power source may be a capacitor module. Two or more, preferably six, capacitors are connected preferably in series. The capacitors are arranged and fixedly attached on a printed circuit board in the capacitor module. Typically, six capacitors of a total capacitance of about 250 to 450 F each, preferably 350 F, may be used to form a total capacitance of 58 F. By way of example, the capacitor module is a super- or ultra-capacitor module such as the “MaxWell 16V 58F ultra capacitor module”. Other standard capacitor modules may be equally used in the device. Advantageously, capacitor modules achieve very high discharging currents providing high power, which is required for the inflation of an avalanche airbag.

Depending on the current the capacitors and capacitor modules may be fully charged in less than 2 min. Batteries usually need more than 2 hrs to be fully charged. Thus, capacitors and capacitor modules are advantageous for the use as power supply in a device according to the invention. The capacitor module may have a weight of 300 to 600 g, preferably 440 g, and dimensions of 100-160 mm×60-120 mm×40-80 mm, preferably 120 mm×85 mm×66 mm.

The device may have a maximum weight of 600 to 1400 g, preferably 1000 g.

The device may have a size of 150-250 mm×100-200 mm×80-180 mm, preferably 190 mm×140 mm×130 mm.

The capacitors of the capacitor module may be connected in series.

The capacitors of the capacitor module may be chosen such that the motor of the device has a power of more than 700 W, preferably 700 to 1200 W, for about 2 sec, when operated with the fully charged capacitors. At the same time the inflation member may rotates with a high speed, between 35,000 and 45,000 .

Then, during the discharge of the capacitor the power may decrease to 200 to 300 W from 2 to 8 seconds.

The capacitors of the capacitor module may be chosen such that the current is above 50 A, preferably 50 to 80 A, for about 2.5 sec, when operated with the fully charged capacitors. At the same time the tension may be above 12 V.

The device may comprise a controller for controlling said motor. By way of example, any commercially available controller such as an electronic speed controller such as “Dr Mad Thrust 85A ESC for EDF “(electric ducted fan) may be used.

The controller may be associated with a preferably mechanical trigger mechanism, which triggers the motor for driving the moveable inflation member upon activation. This allows a person to trigger the inflation mechanism on demand, preferably when a contact with an avalanche is expected.

The device may comprise a one-way valve between the first opening and the second opening. Preferably, said one-way valve is arranged between the moveable inflating member and the first opening.

Such a one-way valve, which is also known as unidirectional valve, enables an air flow to enter the inflatable bag. As soon as the air flow is interrupted, the valve will close and the inflated bag is closed and prevented from being deflated. The one-way valve prevents loss of the intaken air after inflating the inflatable bag. Thus, the inflated bag stays inflated. The one-way valve also enables to deflate the bag, if the user opens the valve manually after inflating the inflatable bag.

As described herein, the wording “between the first and second opening” also includes an arrangement of the one-way valve inside the first or second opening and in particular on the first or second opening.

The first opening, the second opening and the removeable inflation member, preferably the impeller, may be formed as a radial fan (also known as centrifugal fan or compressor). The diameter of the first opening may have a diameter in the range of 20 to 60 mm, preferably 35 mm. The radial fan comprises a winding which winds radially around the moveable inflation member. The winding may have an inlet diameter in the range of 60 to 160 mm, preferably 83 mm. The winding winds around the moveable member from 160° to 360°, preferably 360°.

Atmospheric aft which is sucked through the first opening in the radial fan by the moveable inflation member is compressed to between 0.05 to 0.20, preferably 0.10 to 0.15 bar, more preferably 0.12 bar, above ambient pressure and transferred through the second opening into an attached airbag. Like this, large volumes of air are moved (more than 30 litres per second, preferred more than 50 litres per second, more preferred more than 70 litres per second).

The device comprising a radial fan and a one-way valve allows accelerating and compressing the atmospheric air to an initial high static pressure before entering and inflating the airbag. Thus, a higher efficiency and force for inflation is achieved.

Axial systems and semi-radial systems currently used for avalanche airbag systems achieve relatively low static pressures.

The high static pressure generated by a radial fan is advantageous in that it helps to inflate the airbag under all circumstances of an avalanche, in particular heavy snow or impacts on the avalanche safety system. Radial fans are commonly known as turbo chargers e.g. in cars.

The device may comprise first ribs arranged on the internal periphery of said second opening, wherein said ribs are preferably designed as guide vanes for directing the atmospheric air into the inflatable bag. Additionally, the first ribs enable to generate a flow stream which is directed in a specific direction into the inflatable bag.

Alternatively or additionally, the device for inflating an inflatable bag may comprise second ribs which are arranged in a flow path between the first opening and the moveable inflating member. Said ribs are preferably designed as guide vanes for directing the atmospheric air to the moveable inflation member,

Said guide vanes enable to direct an air flow such that the air which is sucked in by the moveable inflation member impacts in an advantageous angle onto the movable inflation member. Such a guiding increases the efficiency of the moveable inflation member. Further, such guide vanes also prevent foreign matter to be sucked in, which could damage the movable inflating member or clog the device.

An interface for a conventional battery may be part of the device. A battery may be connected or connectable to the capacitor for recharging the capacitor by the interface. Since recharging may be made in longer times than inflation, batteries offering less power may be used for recharging the capacitor. The inflation of the bag, however, is always performed using the energy of the capacitor.

The device may also comprise a base battery as basic power supply for the controller and the motor. For this purpose a relatively small and light battery may be used, because high power is not required for control purposes in contrast to inflation of the inflatable bag. The energy required for the inflation is kept separate in the capacitor and serves only for inflating the inflatable bag upon activation while an electronic control may be continuously operating.

The device according to the invention may be an “all in one” system, which is small and light. All components of the device are densely packed in the device,

The device may comprise a main switch to bring it in a working mode. The working mode allows activation of the inflation mechanism.

When the main switch is activated, the device consumes almost no power. This allows maximum autonomy of the device for a long duration.

Preferably, the device comprises acoustic or visual control elements such as e.g. three LEDs which indicate the charging level of the power supply. Preferably, three lighted-up LEDs indicate maximum charging level, two lighted-up LEDs indicate intermediate charging level and one lighted-up LED indicates low charging levels of the power supply. The latter indicates that charging of the power supply is necessary.

The device may comprise a plug for a charger and/or at least one plug or a wireless communication interface for an external electronic device, such as a mobile phone, smart phone, and tablet. The connected electronic device may send a safety SMS informing that the unit was activated due to an avalanche accident or global positioning system data are send to a rescue service.

The inflation of the inflatable bag should last not more than 5 sec.

The inflation member, preferably the impeller, of the device may be axially or semi-radially arranged in relation to the flow path of the air into the inflatable bag. This allows optimal delivery of atmospheric air to a connected inflatable back. The axial arrangement is optimal for the flow of atmospheric air but generates little static pressure. The semi-radial arrangement generates a higher static pressure but is less effective than a radial arrangement such as a radial fan. Radial arrangements such as a radial fan allow transfer of large volumes of atmospheric air (over 30 litres per second, preferred over 50 litres per second, more preferred 70 litres per second) by achieving a high static pressure in the range of 0.05 to 0.20 bar, preferably 0.10 to 0.15 bar, more preferably 0.12 bar.

A further aspect of the invention relates to an avalanche safety system which comprises the aforementioned device. The avalanche safety system further comprises an inflatable bag attached to the device, preferably via the second opening. According to this aspect, it is possible to provide a complete rescue system. Advantageously, the avalanche system can be fitted to a bag, preferably a backpack.

The invention further relates to a backpack comprising the aforementioned device and an inflatable bag attached to the device. Such a backpack is ready-to-use.

The invention further relates to the use of a capacitor, preferably a capacitor module, as a power supply in a device for an avalanche safety system comprising an inflatable bag.

### BRIEF DESCRIPTION OF THE DRAWINGS

Advantageous embodiments of the invention are described with respect to the following figures:

FIG. 1: a perspective view of a device according to the invention;

FIG. 2: an exploded view of the device according to FIG. 1 comprising a one-way valve;

FIG. 3: a graph of power and rotations per min over time of a device according to the invention;

FIG. 4: a graph of current and tension over time of a device according to the invention.

### DETAILED DESCRIPTION OF THE PREFERRED EMBODIMENTS

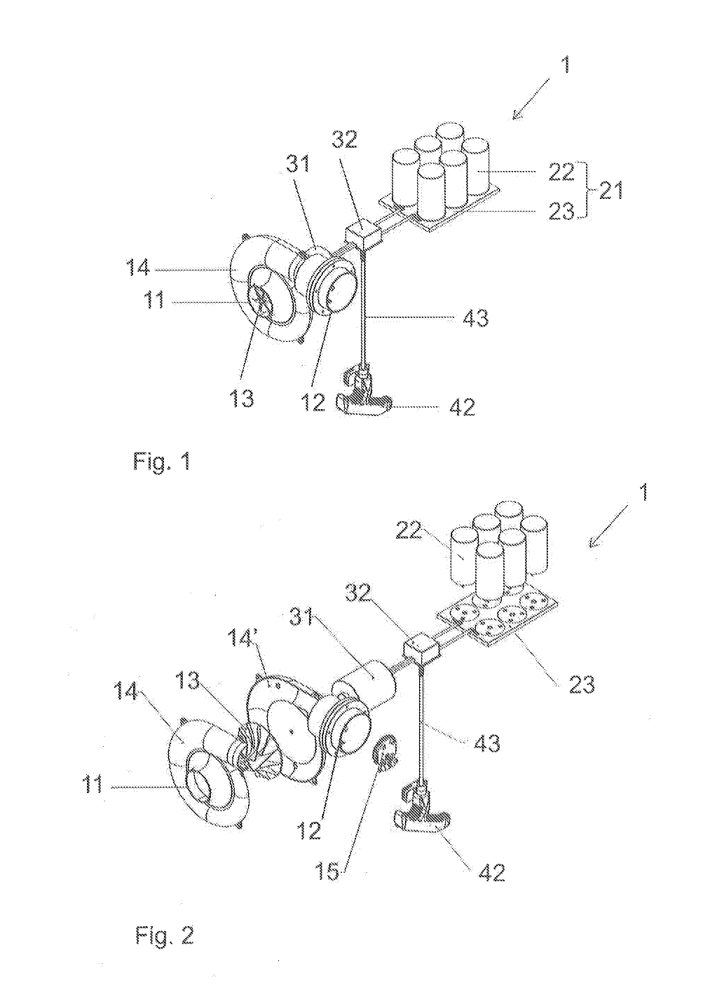

FIG. 1 shows a device 1 comprising a first opening 11 and a second opening 12. The first opening 11 allows intake of atmospheric air sucked in by an impeller 13. The atmospheric air is guided through winding 14, which forms a channel, to the second opening 12. The first opening 11, the second opening 12 and the impeller 13 are arranged as a radial fan including the winding 14. The impeller 13 is driven by a motor 31. The device 1 further comprises a controller 32, which controls the motor 31. Further, the device comprises a capacitor module 21. The capacitor module 21 comprises six capacitors 22 and a main board 23. The capacitors 22 are connected in series on the main board 23. The controller 32 is connected via an electrical connection to a handle 42. The device comprises first ribs arranged on the internal periphery of the second opening 12 (not shown). The device comprises second ribs arranged in the flow path between the first opening 11 and the impeller 13 (not shown).

The device 1 is activatable by actuating the handle 42. The electrical connection 43 activates the controller 32, which controls the motor 31. Upon actuating the handle 42, the motor 31 is energized by the capacitor module 21. The motor 31 drives the impeller 13.

FIG. 2 shows the same feature as shown in FIG. 1. In addition, a one-way valve 16 is positioned between the first opening 11 and the second opening 12. The one-way valve 15 enables controlling the air flow into an inflatable bag (not shown), which is connected to the second opening 12. As soon as the air flow is interrupted or stopped, the inflatable bag is closed by the one-way valve so that intaken air is not released, thus preventing the inflated bag from being deflated.

An exemplary capacitor module according to the invention has a tension of 16 V, a maximum peak current of 203 A and a capacitance of 58 F. Each capacitor of the capacitor module has a tension of 2.7 V with an absolute maximum current of 170 A and a capacitance of 350 F. The capacitor module comprises 6 capacitors connected in series. Relevant parameters and characteristics of the capacitor module are as follows:

| Rated voltage | 16 V |
|---|---|
| Absolute max. voltage | 17 V |
| Rated capacitance | 58 F. |
| Capacitance tolerance | 0-10% |
| ESR (DC) | 22 mOhm |
| Maximum continuous current (at 15° C.) | 35 A |
| Maximum peak current | 203 A |
| Short circuit current | 727 A |
| Maximum leakage current (72 hrs/mA) | 0.3 mA |
| Capacitance of individual capacitors | 350 F. |
| Power density | 3221 W/kg |
| Maximum energy | 2.1 W · h |
| Energy density | 4.8 W/kg |
| Number of capacitors | 6 |
| Operating temperature range | −40 to 65° C. |
| Storage temperature range | −40 to 65° C. |
| Weight | 440 gr. |
| Cycle life | ≥500000 |

An exemplary impeller according to the invention has a diameter of 75 mm, comprises 12 blades having a thickness of 3.8 mm. The impeller rotates with up to 50,000 rpm varying over the time during discharge.

An exemplary winding 14 has a channel diameter at the first opening 11 of 35 mm and at the impeller 13 of 83 mm. The winding 14 completes 360 degree. Atmospheric air sucked by the impeller is compressed to 0.10 to 0.15 bar, preferably 0.12 bar. The impeller 13, the first opening 11, the second opening 12 and the winding 14 may be comprised in a unit such as a radial fan.

The second opening 12 has an inlet diameter of 33 m.

The motor 31 is designed such that an inflatable bag with a volume of 150 litres is inflated at least in 5 sec. The motor achieves 30,000 to 45,000 rpm for at least 8 sec. The specifications of the motor are:

| | |
|---|---|
| Voltage | 8 to 16 V |
| rpm/V | 3000 kV |
| Max. current | 85 A |
| Max. power | 1300 watts |
| rpm | 24′000 to 48′000 |

The controller 32 controls the motor 31, which is a brushless motor (also known as electronically commutated motor). The controller is designed such, that inflation is limited to 6 to 8 sec. The controller 32 has a voltage of 8 to 22 V, an continuous output current of 85A and a peak output current of 100 A.

An exemplary inflatable bag has a volume of 150 litres and remains inflated for at least 3 min once it was inflated. The inflatable back is durable and resistant.

The handle 42 allows actuating the device 1 if necessary e.g. in the event of an avalanche.

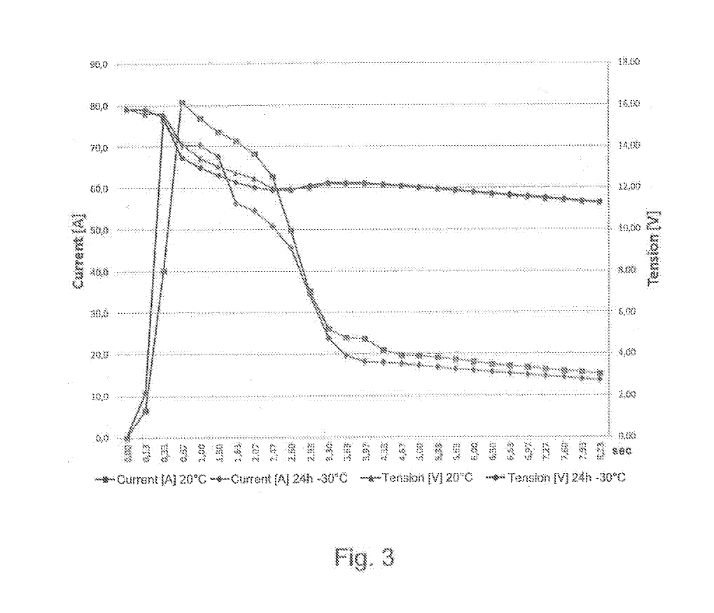

FIG. 3 shows a graph of power of the capacitor module and rotations per min of the motor over time of an exemplary device according to the invention. Measurements were performed at 20° C. and at −30° C., wherein for the latter the device was kept at −30° C. for 24 hrs prior to the measurement. The measurements were performed using a device according to the invention comprising a capacitor module with six capacitors (MaxWell 16V 58F ultra capacitor module) and a motor (Dr Mad Thrust 3000 kv 70 mm EDF Runner Motor 4s version (29 mm)).

The power was measured at 20° C. and at −30° C. for approximately 8 sec. The graph indicates that the power is above 700 W within the first 1.3 sec, and then decreases to 300 W at 3.5 sec and stays at a plateau of about 200 W until the end of the measurement.

The rpm per min of the motor were also measured at 20° C. and −30° C. for approximately 8 sec. The graph indicates that the rotation of the motor is above 45,000 rpm/min within the first 0.5 sec, decreases to 35,000 rpm/min after 3.5 sec and stays constant until the end of the measurement.

The measurements show that there is no significant difference in performance (power and rotation per min) between a device according to the invention operated at 20° C. and a device according to the invention operated at −30° C., which was at −38° C. for 24 hrs prior to the measurement.

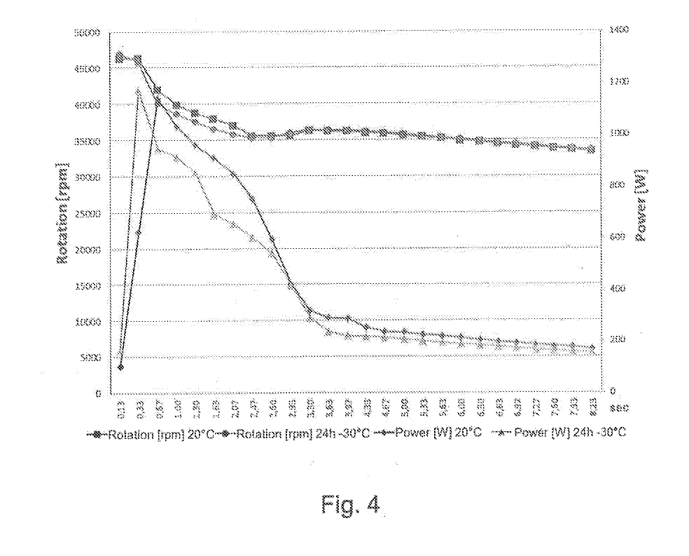

FIG. 4 shows a graph relating to current and tension over time of an exemplary device according to the invention. The measurements correspond to the performed measurements shown in the graph of FIG. 3. Current and tension are plotted over time.

The current of the system reaches a maximum of about 80 Ampere for both measurements (20° C. and −30° C.) within the first second upon activation, decreases to 20 Ampere within 4 sec and plateaus at about 15 Ampere till the end of the measurement at 8.3 sec.

The tension of the system starts at about 16 Volt, decreases to 12 Volt after 2.5 sec and stays constant till the end of the measurement.

The measurements show that there is also no significant difference in the electrical properties (current and tension) between a device according to the invention operated at 20° C. and a device according to the invention operated at 30° C., which was at −30° C. for 24 hrs. prior to the measurement.

1-17. (canceled)

18. A device for inflating an inflatable bag comprising:
a first opening allowing intake of atmospheric air,
a second opening connected to or connectable to the inflatable bag,
at least a first moveable inflation member being arranged between said first opening and said second opening,
a motor for driving the removeable inflation member, and
a power source for energizing the motor,
wherein the power source comprises at least one capacitor as a power supply for said motor.

19. The device according to claim 18, wherein the at least one capacitor has a total capacitance in a range of 20 to 90.

20. The device according to claim 18, wherein the power source is a capacitor module, and at least two capacitors are connected on a main board.

21. The device according to claim 20, wherein capacitors of the capacitor module are connected in series.

22. The device according to claim 21, wherein the device has six capacitors.

23. The device according to claim 20, wherein the capacitors are chosen such that the motor has a power of more than 700 W, for about 2 sec, when operated with fully charged capacitors.

24. The device according to claim 20, wherein the capacitors are chosen such that the current is above 50 A, for about 2.5 sec, when operated with fully charged capacitors.

25. The device according to claim 18, further comprising a controller for controlling said motor.

26. The device according to claim 25, wherein said controller is associated with a trigger mechanism which triggers the motor for driving the moveable inflation member upon activation.

27. The device according to claim 18, wherein the device comprises a one-way valve, between the first opening and the second opening, for preventing loss of intake air after inflating the inflatable bag.

28. The device according to any of claim 18, wherein the first opening, the second opening and the moveable inflation member are arranged so as to form a radial fan.

29. The device according claim 18, wherein the device comprises an interface for a battery being connected or connectable to the capacitor for recharging the capacitor.

30. The device according to claim 18, wherein the device has a maximum weight in a range of 600 to 1400 g.

31. The device according to claim 18, wherein the device has a size in a range of 150-250 mm×100-200 mm×80-180 mm.

32. The device according to claim 18, the device further comprises a main switch.

33. The avalanche safety system comprising a device according to claim 18 and an inflatable bag attached to the device.

34. A backpack comprising a device according to claim 18 and an inflatable bag attached to the device.

35. The device according to claim 29, wherein the inflation member is an impeller.

36. The device according to claim 19, wherein the at least one capacitor has a total capacitance in a range of 50 F to 70 F.

37. The device according to claim 36, wherein the at least one capacitor has a total capacitance of about 58 F.

38. The device according to claim 24, wherein said power is 700 to 1200 W.

39. The device according to claim 25, wherein said current is 50 to 80 A.

40. The device according to claim 27, wherein the trigger is a mechanical trigger.

41. The device according to claim 28, wherein said one-way valve is arranged between the moveable inflation member and the first opening.
